(19) United States
(12) Patent Application Publication
(10) Pub. No.: US 2026/0094010 A1
(43) Pub. Date: Apr. 2, 2026

(54) MACHINE LEARNING BASED APPROACH FOR AUTOMATICALLY GENERATING A COMPLIANCE GRAPH FOR COMPLETING A WORKFLOW

(71) Applicant: INTUIT INC., Mountain View, CA (US)

(72) Inventors: Karelia Del Carmen PENA-PENA, Wilmington, DE (US); Malathy MUTHU, The Woodlands, TX (US); Adam NEELEY, Alexandria, VA (US)

(21) Appl. No.: 18/901,438

(22) Filed: Sep. 30, 2024

(51) Int. Cl. G06N 5/02

(52) U.S. Cl. CPC G06N 5/02

(57) ABSTRACT

A method for automatically generating a compliance graph for a workflow is provided. The method includes providing a set of forms as an input to a language processing machine learning model. The set of forms are related to the workflow and include a plurality of fields for receiving user-input. The method includes generating, using the language processing machine learning model, a plurality of nodes based on the plurality of fields, with at least one node of the plurality of nodes is represented as a quadruple. The method includes generating, using the language processing machine learning model, the compliance graph for the workflow based on the plurality of nodes, with the compliance graph providing a visual representation of a logic flow associated with completing the workflow in a compliant manner.

### INTRODUCTION

Aspects of the present disclosure are directed to machine learning techniques for automatically generating a compliance graph for completing a workflow.

### BACKGROUND

A software application may be deployed for use by many users to complete a specific workflow. For example, the workflow may include preparing an electronic document (e.g. tax return) for a user based on the user's responses to multiple questions included in one or more source documents (e.g., tax forms). To prepare the electronic document, the software application may display the multiple questions (e.g., one at a time) within a user interface (e.g., running on a client device) having one or user interface elements that the user may interact with to provide a response to each of the questions.

One or more of the questions included in the source document(s) may not be relevant to the user, and generating and displaying content (e.g., questions) that is not relevant to a user represents a waste of computing resources. Existing computer-based techniques for filtering content that is not relevant to a user interacting with a software application to complete a requested workflow (e.g., prepare an electronic document) are error-prone. As a result, workflows completed using software applications are typically verified manually by a user having knowledge of requirements associated with completing the requested workflow, such as preparing an electronic document (e.g., financial document) that is subject to regulatory requirements that may change (e.g., annually).

Accordingly, a need exists for improved techniques for determining whether a requested workflow is compliant.

### BRIEF SUMMARY

Certain embodiments provide a method for automatically generating a compliance graph for a workflow. The method generally includes: providing a set of forms as an input to a language processing machine learning model, the set of forms related to the workflow and including a plurality of fields for receiving user-input; generating, using the language processing machine learning model, a plurality of nodes based on the plurality of fields, wherein at least one node of the plurality of nodes is represented as a quadruple; and generating, using the language processing machine learning model, the compliance graph for the workflow based on the plurality of nodes, wherein the compliance graph provides a visual representation of a logic flow associated with completing the workflow in a compliant manner.

Other embodiments comprise systems configured to perform the method set forth above as well as non-transitory computer-readable storage mediums comprising instructions for performing the method set forth above.

Certain embodiments provide a method for performing a workflow. The method generally includes: obtaining a compliance graph for the workflow, the compliance graph generated based on a plurality of nodes, wherein the plurality of nodes are generated based on a plurality of fields included in a set of forms related to the workflow, and wherein one or more nodes included in the plurality of nodes are represented as a quadruple; displaying a first page on a display screen of a computing device, the first page including a first field of the plurality of fields; receiving user input for the first field; and determining a second page following the first page and including a second field of the plurality of fields may be skipped based on the compliance graph and the user input for the first field.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts a computing environment for completing a workflow according to some embodiments of the present disclosure.

FIG. 2 depicts a computing environment for automatically generating a compliance graph for a workflow according to some embodiments of the present disclosure.

FIG. 3 depicts a data flow diagram for generating a compliance graph for a workflow according to some embodiments of the present disclosure.

FIG. 4 depicts an example form related to completing a workflow according to some embodiments of the present disclosure.

FIG. 5 depicts an example visual representation of a compliance graph according to some embodiments of the present disclosure.

FIG. 6 depicts example operations for automatically generating a compliance graph for a workflow according to some embodiments of the present disclosure.

FIG. 7 depicts example operations for performing a workflow according to some embodiments of the present disclosure.

FIGS. 8A and 8B depict example processing systems according to some embodiments of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically generating a compliance graph for a workflow within a given domain.

Example aspects of the present disclosure are directed to machine learning based techniques for automatically generating a compliance graph for a given workflow (e.g., preparing an electronic document) within a given domain (e.g., finance). The disclosed techniques may include providing a set of forms related to the workflow as an input to a language processing machine learning model (e.g., large language model). Each form included in the set of forms may include multiple fields for inputting information (e.g, name, date of birth, primary residence), and the language processing machine learning model may be trained to represent each of the fields as a separate node of the compliance graph. The language processing machine learning model may also be trained to identify relationships amongst the different fields such that the compliance graph generated by the language processing machine learning model provides a logical flow for completing the workflow in a compliant manner (e.g., according to regulatory requirements associated with the workflow) while also limiting content (e.g., requests for information) associated with the workflow to content that is relevant to a user for whom the workflow is requested.

In some embodiments, the language processing machine learning model may be trained to initially define each respective node (e.g., respective field in the set of forms) of the compliance graph as a triplet. For instance, defining a respective node of the compliance graph as a triplet may include determining a type (e.g., required, covered, conditionally required, conditionally covered) for the respective node; determining one or more conditions (e.g., user input, instructions, etc.) affecting whether users can skip (e.g., leave blank) the respective node; and generating a rationale for the determined type and/or condition(s). The machine learning model may be further trained to define the respective node as a quadruple by mapping the condition(s) determined for the respective node to one or more related nodes of the compliance graph. The machine learning model may then generate the compliance graph based on the nodes having the quadruplet format and, as a result, the compliance graph may be improved (e.g., in terms of accuracy and relevance in compliance mapping) compared to existing knowledge graph based techniques that rely on the triplet format.

Aspects of the present disclosure provide numerous technical effects and benefits. For example, by using a language processing machine learning model to dynamically construct a compliance graph for a workflow, the disclosed techniques provide an improved approach (e.g., less error prone) compared to existing techniques, such as knowledge graphs, that rely on predefined or otherwise configured ontologies and manually tagging. Furthermore, by using a language processing machine learning model to generate compliance graphs with nodes having the quadruplet format, the disclosed techniques provide improved performance (e.g., in terms of precision and accuracy) in compliance mapping compared to existing approaches (e.g., knowledge graphs) that use the triplet format. As a result, content being displayed to a user according to a compliance graph generated using the disclosed techniques is less likely to be irrelevant to the user. In this manner, computing devices implementing the disclosed techniques are less likely to waste computing resources associated with generating content for display that is irrelevant to the user and, similarly, are less likely to waste computing resources associated with processing user input related to displayed content that is irrelevant to the user.

### Example Computing Environment for Completing a Workflow

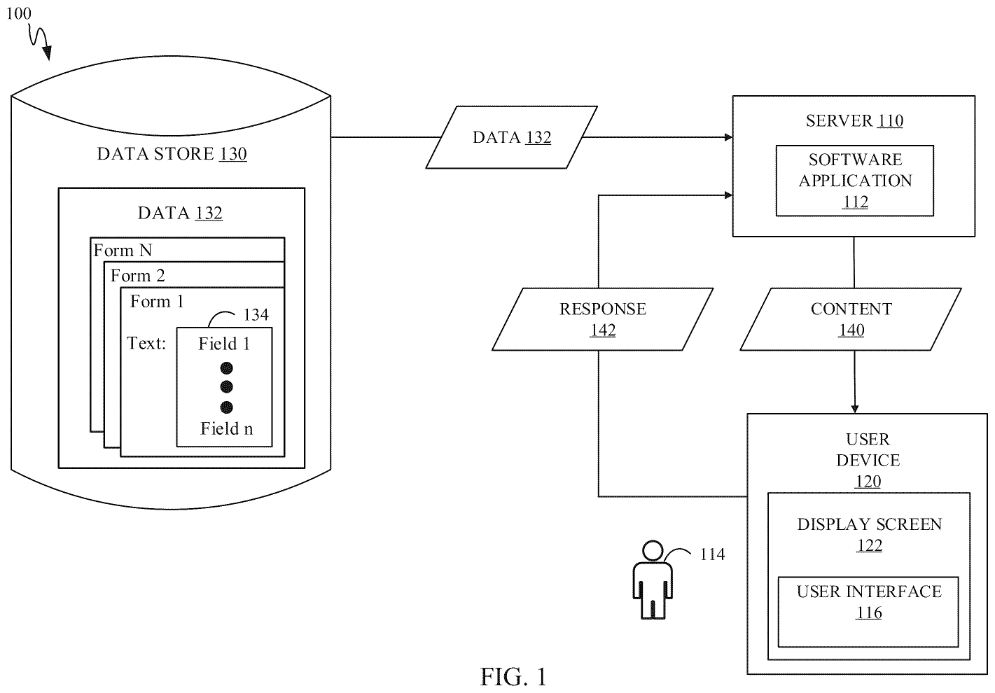

FIG. 1 depicts an example computing environment 100 for completing a workflow according to some embodiments of the present disclosure. In some embodiments, the workflow may be preparing a document within a given domain. For example, the computing environment 100 may be used to prepare a financial document, such as a tax return.

The computing environment 100 may include a server 110, a user device 120, and a data store 130 connected to one another via one or more networks (not shown). Examples of the network(s) may include a wide area network (WAN) or a local area network (LAN).

In some embodiments, the server 110 may include a software application 112 configured to perform actions associated with completing the workflow for a user 114. For example, the software application 112 may configure the server 110 to obtain data 132 stored on the data store 130. In some embodiments, the data 132 stored on the data store 130 may include a plurality of forms (e.g., illustrates as Form 1, Form 2, Form N). Each of the plurality of forms may be relevant to preparing the document within the domain and may include a plurality of fields 134. Each respective field of the plurality of fields 134 included in a respective form of the plurality of forms may correspond to a different request of a plurality of requests for information included in the respective form.

It should be appreciated that the plurality of forms may be related to different topics and, as a result, the information requested by one form may be different from the information being requested by another form. As an example, a first form (e.g, Form 1) of the plurality of forms may request background information (e.g., legal name, date of birth, residence, etc.) for the user 114, whereas a second form (e.g., Form 2) of the plurality of forms may request financial information for the user 114.

The software application 112 may configure the server 110 to generate content 140 based on the data 132. In some embodiments, the content 140 may be similar to one of the forms included in the data 132 stored on the data store 130. For example, the content 140 may be a page, such as a webpage, including text from a first form (e.g., Form 1) of the plurality of forms. The text may identify the information (e.g., name, date of birth, residence, etc.) requested in the first form. The webpage may further include a plurality of different fields, with each of the fields corresponding to different information. For example, the plurality of fields may include a first field for the user 114 to provide (e.g., enter) his or her first name, a second field for the user 114 to enter his or her last name, and a third field to enter his or her date of birth.

In some embodiments, the software application 112 may configure the server 110 to communicate the content 140 to the user device 120 for display on a display screen 122 of the user device 120. More specifically, the software application 112 may include a user interface 116 displayed on the display screen 122 and the content 140 may be displayed within the user interface 116. The user 114 may interact with the user interface 116 to generate a response 142 to the content 140. More specifically, the content 140 may include the page described above and the user 114 may interact with the user interface 116 to input information into each of the plurality of fields included on the page.

The user device 120 may be configured to communicate the response 142 to the server 110. For example, in some embodiments, the user device 120 may communicate the response 142 in real-time as the user 114 is interacting with the user interface 116 to input the requested information. In alternative embodiments, the user device 120 may communicate the response 142 once the user 114 finishes inputting all the requested information. For example, in some embodiments, the user interface 116 may include a user interface control that the user 114 may interact with (e.g., select) to indicate that the user 114 has input all the requested information.

In some embodiments, the software application 112 may configure the server 110 to communicate content 140 individually for each of the plurality of forms. For example, the software application 112 may configure the server 110 to communicate content 140 related to a first form (e.g., Form 1) of the plurality of forms, receive the response 142 to the content 140 related to the first form and, in response to receiving the response 142, communicate content 140 related to a second form (e.g., Form 2) of the plurality of forms. It should be appreciated that this process may be iteratively performed until the server 110 has generated content 140 for each of the plurality of forms and collected response 142 for each of the plurality of forms.

In some instances, the plurality of forms may request information that is not relevant to the user 114. For example, a first form (e.g., Form 1) included in the plurality of forms may, in addition to requesting information that is relevant to the user 114, request information that is not relevant to the user 114. Furthermore, in some instances, the information included in a second form (e.g., Form 2) of the plurality of forms may either be relevant to the user 114 or irrelevant to the user 114 depending the user's response to information requested in a different form, such as the first form, of the plurality of forms.

The content 140 that the software application 112 configures the server 110 to generate for a given form includes all the information requested in the form regardless of whether the form requests information that is irrelevant to the user 114. While comprehensive, this approach is rigid and, as a result, computing resources within the computing environment 100 are used in an inefficient manner. For example, computing resources on the server 110 are used inefficiently by generating content (e.g., content 140) that is irrelevant to the user 114. Additionally, computing resources on the user device 120 are used inefficiently by generating a response (e.g., response 14) to content that is irrelevant to the user 114. Furthermore, the network (e.g., WAN, LAN) that the server 110 and the user device 120 use to communicate with one another may be used inefficiently, because the limited bandwidth of the network may be used by the server 110 to communicate a request for irrelevant information and may also be used by the user device 120 to communicate a response to the request for irrelevant information.

### Example Computing Environment for Automatically Generating a Compliance Graph for a Workflow

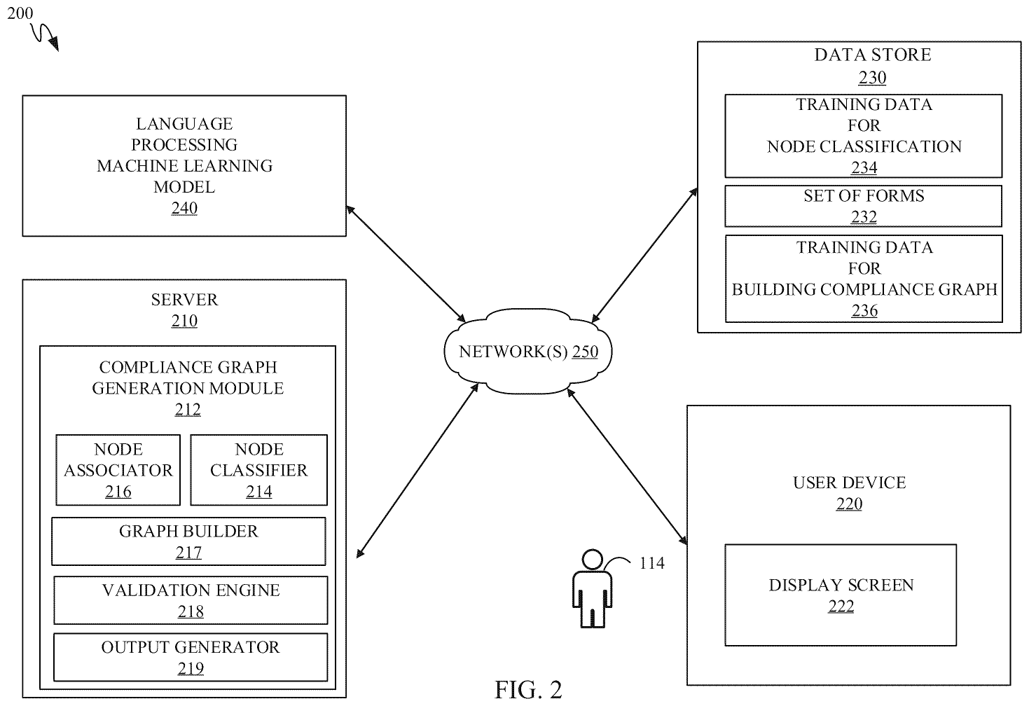

FIG. 2 depicts an example computing environment 200 for automatically generating a compliance graph for a workflow according to some embodiments of the present disclosure. The compliance graph may be related to completing a domain-specific workflow, such as preparing a domain-specific document for the user 114.

The computing environment 100 can include a server 210, a user device 220, a data store 230, and a language processing machine learning model 240 (e.g., large language model) connected to one or more networks 250 over which data can be transmitted. Examples of the network(s) 250 can include, without limitation, a wide area network (WAN), a local area network (LAN), and/or a cellular network.

The server 210 can include a software application 212 (e.g., labeled compliance graph generation) configured to generate a compliance graph for the workflow. For example, as discussed above, the requested workflow may be preparing a domain-specific document, such as a financial document (e.g., tax return). The software application 212 may configure the server 210 to communicate with the data store 230 to cause the data store 230 to provide a set of forms 232 related to the workflow as an input to a node classifier 214.

The set of forms 232 may include a plurality of different forms related to the workflow. Each of the plurality of different forms may include multiple fields, with each of the fields being associated with inputting information about the user 114. For example, a first field included in a first form of the set of forms 232 may be for inputting a first name of the user 114, whereas a second field included in the first form may be for inputting a last name of the user 114.

In some embodiments, the software application 212 may include the node classifier 214. For example, the node classifier 214 may be a module of the software application 212. In alternative embodiments, the node classifier 214 may be a machine learning model. For example, in some embodiments, the language processing machine learning model 240 may be configured as the node classifier 214.

The training data 234 for node classification may provide a framework for the node classifier 214 to classify the plurality of fields included in the set of forms 232 as separate nodes of the compliance graph. In some embodiments, the training data 234 for node classification may include a set of rules (e.g., predefined or otherwise configured) for classifying each respective field the plurality of fields as separate nodes of the compliance graph, with each node having a particular format. For example, the particular format may include a triplet format in which each respective node has: i) a type; ii) one or more conditions; and iii) a rationale for the type, the condition(s), or both.

In embodiments in which the language processing machine learning model 240 is the node classifier 214, the training data 234 for node classification may include few-shot training examples for fine-tuning the language processing machine learning model 240 to classify each of the plurality of fields included in the set of forms 232 as a respective node of the compliance graph. Furthermore, the few-shot training examples may fine-tune the language processing machine learning model to define each of the plurality of nodes according to the particular format (e.g., triplet format) discussed above.

In some embodiments, the node classifier 214 may be configured to classify each of the respective nodes of the compliance graph as one of the following types: i) required; ii) covered; iii) conditionally required; or (iv) conditionally covered.

In some embodiments, the node classifier 214 may classify a node (e.g., field) as required if the user 114 cannot skip (e.g., leave blank) the node. An example of a required node may be a node corresponding to a field included in the set of forms 232 that is for entering a name (e.g., first or last) of the user 114. In some embodiments, the node classifier 214 may classify a node as covered if the user 114 can skip the node. An example of a covered node may be a node corresponding to a field included in the set of forms 232 that is for entering a second name (e.g., nickname) of the user 114. In some embodiments, the node classifier 214 may classify a node as conditionally required if: i) the node is relevant to the user 114 only if a specific condition applies; and ii) the user cannot skip the field if the specific condition applies. In some embodiments, the node classifier 214 may classify a node as conditionally covered if: i) the node is relevant to the user 114 only if a specific condition applies; and ii) the user 114 can skip the node even if the specific condition applies.

In some embodiments, the node classifier 214 may be configured to determine whether one or more conditions exist that may prevent the user 114 from skipping (e.g., leaving blank) a respective node (e.g. field in one of the forms included in the set of forms 232) of the compliance graph. Examples of the one or more conditions may include, without limitation, i) the choice of the user 114 choice for a previous node (e.g., field) of the compliance graph that is associated with the same form in the set of forms 232 or a different form in the set of forms 232; ii) instructions associated with the same form or the different form; or iii) external documents (e.g., website) providing accompanying information for completing the form.

In some embodiments, the node classifier 214 may be configured to generate a rationale for each respective node of the compliance graph. For example, the node classifier 214 may generate a rationale for the type (e.g., required, covered, conditionally required, conditionally required) the node classifier 214 determined for a given node. Alternatively, or additionally, the node classifier 214 may, if applicable, generate a rationale for the condition(s) the node classifier 214 determined for the given node. In some embodiments, the rationale generated by the node classifier 214 for the given node (e.g., field) of the compliance graph may be grounded in text (e.g., included in the forms in the set of forms 232), instructions, or prior knowledge.

In some embodiments, the node classifier 214 may provide the plurality of nodes (e.g., having the triplet format) for the compliance graph as an input to a node associator 216. The node associator 216 may, for each respective node of the compliance graph having condition(s) affecting whether the user 114 may skip the respective node, determine one or more other nodes of the compliance graph are associated with (e.g., related to) the respective node. For example, the node associator 216 may be configured to map the condition(s) determined for the respective node of the compliance graph to one or more other nodes of the compliance graph. In this manner, the node associator 216 may generate an additional parameter (e.g., associated node(s)) for the respective node of the compliance graph and, as a result, the respective node of the compliance graph may have a quadruple format (e.g., type, condition(s), rationale, associated node(s)).

In some embodiments, the software application 212 may include the node associator 216. For example, the node associator 216 may be a module included in the software application 212. In alternative embodiments, the node associator 216 may be a machine learning model. For example, the language processing machine learning model 240 may be configured as the node associator 216.

In embodiments in which the language processing machine learning model 240 is the node associator 216, the software application 212 may configure the server 210 to generate a prompt to instruct the language processing machine learning model 240 to map the condition(s) for a given node of the compliance graph to one or more other nodes of the compliance graph. More specifically, the language processing machine learning model may be prompted to map one or more conditions for a given field included in a first form of the set of forms 232 to one or more fields included in the first form and/or one or a different form in the set of forms 232.

In some embodiments, the node associator 216 may provide the plurality of nodes (e.g., having the quadruplet format) for the compliance graph as an input to a graph builder 217. The graph builder 217 may be configured to generate (e.g., build) the compliance graph for the workflow based on the nodes (e.g., having the quadruplet format) received from the node associator 216.

In some embodiments, the software application 212 may include the graph builder 217. For example, the graph builder 217 may be a module of the software application 212. In alternative embodiments, the graph builder 217 may be a machine learning model. For example, in some embodiments, the language processing machine learning model 240 may be configured as the graph builder 217.

In embodiments in which the language processing machine learning model 240 is the graph builder 217, the software application 212 may configure the server 210 to communicate with the data store 230 to cause the data store 230 to provide training data 236 for building compliance graphs as an input to the language processing machine learning model 240 to configure (e.g., fine-tune) the language processing machine learning model 240 for this particular purpose (that is, building compliance graphs for workflows).

In some embodiments, the training data 236 for building compliance graphs may include few-shot training examples of compliance graphs for different workflows. The few-shot training examples may be used to fine tune the language processing machine learning model 240 to generate compliance graphs for workflows. For example, the few-shot training examples may fine tune the language processing machine learning model 240 to generate compliance graph having a particular format (e.g., the few-shot training examples may be provide to the language processing machine learning model 240 along with a prompt). In some embodiments, the particular format may include a plurality of nodes, with each node in the compliance graph connected to one or more other nodes in the compliance graph via one or more edges. It should be understood that an edge defines a relationship between two nodes with the compliance graph.

Once the language processing machine learning model 240 is configured (e.g., fine-tuned) to generate compliance graphs for workflows, the language processing machine learning model 240 may generate a compliance graph for the workflow based on the nodes (e.g., having the quadruple format) received from the node associator 216.

In some embodiments, the language processing machine learning model 240 may provide the compliance graph for the workflow as an input to a validation engine 218. The validation engine 218 may be configured to automatically cross-check the generated compliance graph for consistency and accuracy.

In some embodiments, the software application 212 may include the validation engine 218. For example, the validation engine 218 may be a module included in the software application 212. In alternative embodiments, the validation engine 218 may be running on a different device (e.g., another server) than the server 210.

In some embodiments, the validation engine 218 may include a machine learning model configured to automatically cross-check compliance graphs for workflows for consistency and accuracy. In this manner, the computing environment 200 provides a higher level of reliability and correctness compared to existing computer-based solutions (e.g., using knowledge graphs) for performing compliance mapping for workflows, such as preparing an electronic document.

In some embodiments, an output generator 219 may be configured to display a visual representation of the compliance graph for viewing by a user (e.g., a subject-matter expert within the domain associated with the workflow). For example, the output generator 219 may be configured to display the visual representation of the compliance graph on a display screen 222 of the user device 220.

In some embodiments, the software application 212 may include the output generator 219. For example, the output generator 219 may be a module included in the software application 212. In alternative embodiments, the output generator 219 may be running on a different device (e.g., another server) than the server 210.

### Example Data Flow Diagram for Automatically Generating a Compliance Graph for a Workflow

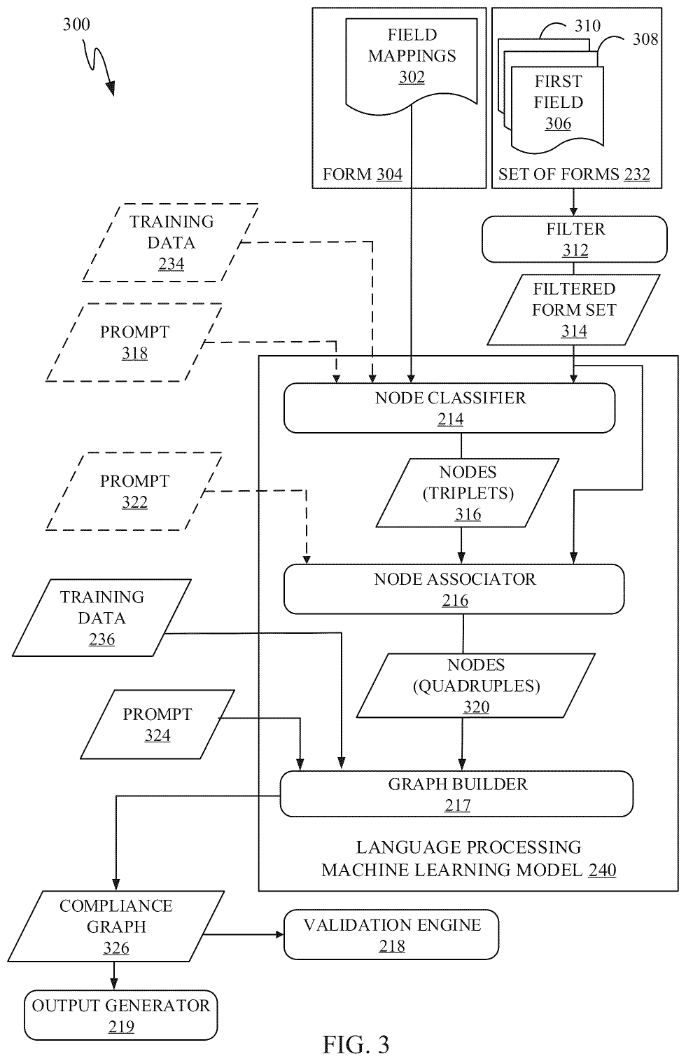

FIG. 3 depicts an example data flow diagram 300 for automatically generating a compliance graph according to some embodiments of the present disclosure. For simplicity, the data flow diagram 300 may be discussed with reference to the computing environment 200 discussed above with reference to FIG. 2. It should be appreciated, however, that the scope of the present disclosure is not limited to automatically generating compliance graphs using the computing environment 200 of FIG. 2 and therefore may cover automatically generating compliance graphs for workflows using other computing environments.

In some embodiments, a field mapping 302 for a form 304 related to the workflow for which a compliance graph is being generated may be provided as an input to the node classifier 214. The form 304 may be included in the set of forms 232 discussed above with reference to FIG. 2 and may include a plurality of fields. Furthermore, in some embodiments, the field mapping 302 for the form 304 may be a data model in which a different variable is mapped to each respective field of the form 304.

As illustrated, the set of forms 232 may also be provided as an input to the node classifier 214. In some embodiments, the set of forms 232 may include a description for each respective field (e.g., first field 306, second field 308, third field 310, etc.) included in each form included in the set of forms 232. The set of forms 232 may further include related instructions for each respective field. As an example, related instruction for the first field 306 of a form (e.g., form 304) included in the set of forms 232 may be from the form itself from or an external source (e.g., third-party website) related to the form.

In some embodiments, the set of forms 232 may be passed through a filter 312 before being provided to the node classifier 214. The filter 312 may be configured to filter (e.g., remove) fields that are not needed for the compliance graph for the workflow. For example, the filter 312 may be configured to filter (e.g., remove) fields from the set of forms 232 related calculations to generate a filtered set of forms 314 that is then provided as an input to the node classifier 214.

The node classifier 214 may be configured to generate nodes 316 of the compliance graph based on the form 304 that is provided as an input to the node classifier 214. For instance, each of the nodes 316 may correspond to a different field included in the form 304. Furthermore, as discussed above with reference to FIG. 2, the node classifier 214 may, for each of the nodes 316, determine the following: i) a node type (e.g., required, covered, conditionally required, conditionally covered); ii) one or more one or more conditions that may change whether a user may skip the respective node; and iii) a rational for the node type, the condition(s), or both.

In some embodiments, a machine learning model may be configured as the node classifier 214. As an example, the language processing machine learning model 240 may be configured as the node classifier 214. In such embodiments, a prompt 318 may be provided to the language processing machine learning model 240 to configure the language processing machine learning model 240 to generate the nodes 316 of the compliance graph based on the form 304. For example, the prompt 318 may include natural language text, such as the example prompt provided below.

Your first step is identifying the state of every field to determine how relevant this field is to the user and if it needs a value from any type of user independent of the specific situations that might apply. Keep in mind the following:
Return as many conditions as possible that are relevant to the field in question.
Make sure to consider the overall context in text and how, for instance, checking a box or having a value in one field might change the state of other fields.
For each field also consider the conditions under which the section and the form itself is relevant to the user.

In such embodiments, the language processing machine learning model 240 may, in addition to the prompt 318, be provided a set of rules (e.g., predefined or otherwise configured) for assigning a type (e.g., required, covered, conditionally required, conditionally covered). In alternative embodiments, the language processing machine learning model 240 may be provided training data 234 including few-shot examples for fine tuning the language processing machine learning model 240 to function as the node classifier 214.

As illustrated, the node 316 and the filtered set of forms 314 may be provided as inputs to the node associator 216. The node associator 216 may, for each respective node included in the nodes 316 generated by the node classifier 214, determine one or more other nodes of the compliance graph that are associated with (e.g., related to) the respective node. For example, the node associator 216 may be configured to map the condition(s) determined for a respective node of the nodes 316 to one or more other nodes of the compliance graph. In this manner, the node associator 216 may generate an additional parameter (e.g., associated node(s)) for each node of the nodes 316 and, as a result, the output of the node associator 216 may be nodes 320 having a quadruple format (e.g., type, condition(s), rationale, associated node(s)).

In some embodiments, a machine learning model may be configured as the node associator 216. As an example, the language processing machine learning model 240 may be configured as the node associator 216. In such embodiments, a prompt 322 may be provided to the language processing machine learning model 240 to configure the language processing machine learning model 240 to, for each respective node included in the nodes 316 generated by the node classifier 214, determine one or more other nodes of the compliance graph that are associated with (e.g., related to) the respective node. For example, the prompt 318 may include natural language text, such as the example prompt provided below.

You are an expert analyzing text and identifying perfect matches. You are given a node with a list of conditions and your job is to match each condition to one of the nodes in relevant fields for conditions whenever possible.
If there is not a perfect match, then leave the associated fields blank
If a field is already provided in the condition(s), then add the field to the associated fields

As illustrated, nodes 320 may be provided as an input to the graph builder 217. In some embodiments, the language processing machine learning model 240 may be configured as the graph builder 217. In such embodiments, a prompt 324 may be provided to the language processing machine learning model 240 to configure the language processing machine learning model 240 to generate (e.g., build) the compliance graph for the workflow. For example, the prompt 324 may include natural language text, such as the prompt provided below:
You are a top-tier algorithm designed for extracting information in structured formats to build a knowledge graph. The graph represents a sequence of fields that will be presented to a user in an interview flow.
Your task is to analyze the conditions given for each node and represent these conditions in the graph.
Make sure the result is a directed acyclic graph (DAG) that includes all nodes with its conditions represented in decision nodes.

In such embodiments, the language processing machine learning model 240 may, in addition to the prompt 324, be provided training data 236 including few-shot examples for fine tuning the language processing machine learning model 240 to generate a compliance graph 326 for the workflow. For instance, in some embodiments, the compliance graph 326 may represent the fields included in the form 304 and how a state of those fields are affected by fields in other forms of the set of forms 232. In this manner, the compliance graph 326 may represent a logical flow for ensuring compliance (e.g., with respect to regulatory requirements) for completing the workflow (e.g., completing an electronic document, such as a financial document).

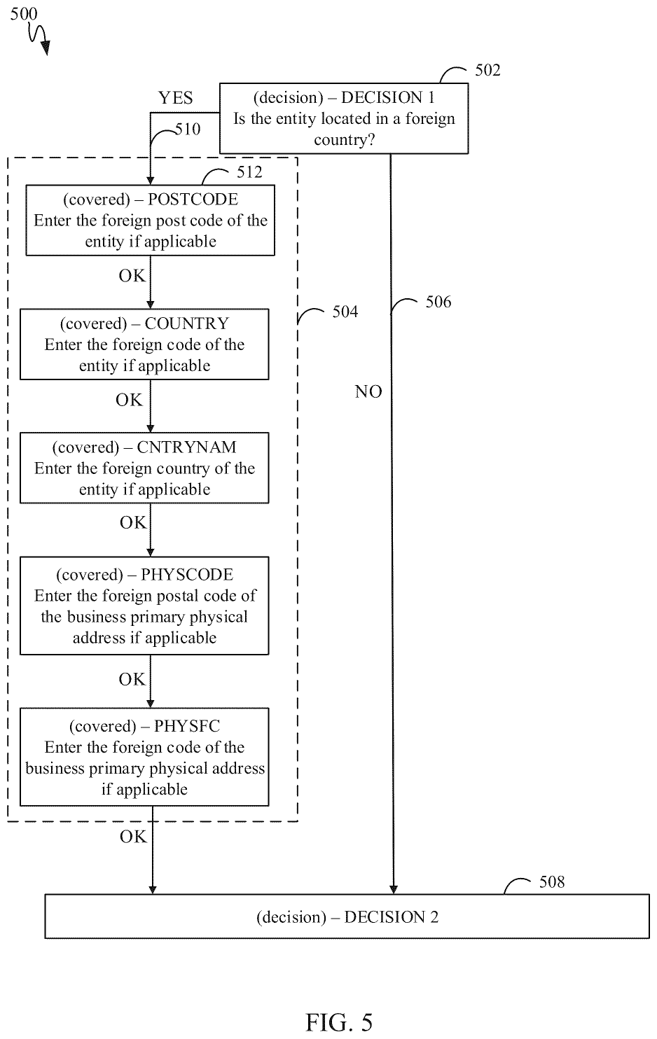

In some embodiments, the compliance graph 326 may be checked for consistency and accuracy. For example, the compliance graph 326 (or data indicative of the compliance graph 326) may be provided as an input to the validation engine 218. In some embodiments, the validation engine 218 may be a machine learning model configured to analyze the compliance graph 326 for consistency and accuracy. Furthermore, in some embodiments, the machine learning model may be trained (and re-trained) based on user feedback provided by experts within a given domain (e.g. preparing tax returns) that manually analyze compliance graphs the language processing model generates for workflows within the domain. In this manner, performance of the machine learning model may, based on the user feedback provided by experts within the domain, in checking compliance In some embodiments, the compliance graph 326 may be provided to the output generator 219 which, as discussed above, may generate a visual representation of the compliance graph 326. For instance, an example of the visual representation of the compliance graph 326 is depicted in FIG. 5 and will be discussed later on in more detail.

### Example Form With Field Mappings

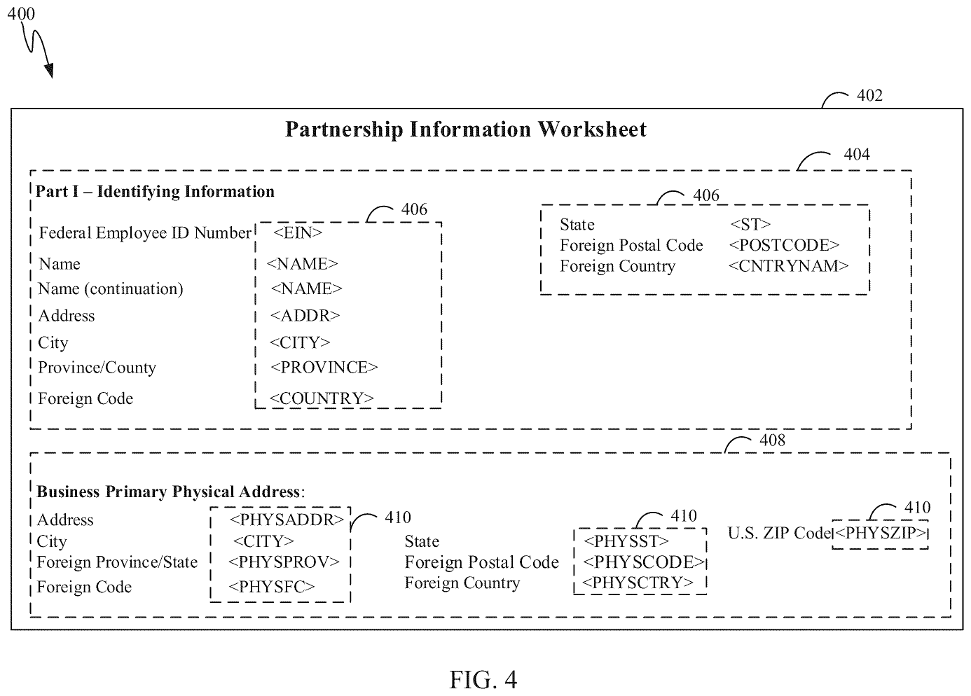

FIG. 4 depicts an example field mapping 400 for a form 402 that may be included in a set of forms related to a workflow according to some embodiments of the present disclosure.

As illustrated, the form 402 may include a first section 404 (e.g., labeled Part I - Identifying Information) including a first set of fields 406 and may further include a second section 408 (e.g., labeled Business Primary Physical Address) including a second set of fields 410. Furthermore, as illustrated, the field mapping 400 may include a different variable (e.g., represented by <VARIABLE NAME>) for each field included in the first set of fields 406 and the second set of fields 410. In this manner, the different fields included in the form 402 may be mapped to a data model used by the computing environment 200 for automatically generating compliance graphs for workflows discussed above with reference to FIG. 2.

### Example Visual Representation of Compliance Graph

FIG. 5 depicts a compliance graph 500 according to some embodiments of the present disclosure. For example, the compliance graph 500 may depict fields included in the form 402 discussed above with reference to FIG. 4.

As illustrated, in some embodiments, the compliance graph 500 may be a directed acyclic graph including a plurality of nodes connected to one other via a plurality of edges. For instance, the compliance graph 500 may include a node 502 representing a condition (e.g., as a decision) affecting whether a user may skip a plurality of fields (e.g., Foreign Postal Code, Foreign Code, Foreign Country, Foreign Code) included in the second section 408 of the form 402. It should be understood the plurality of fields are represented as a plurality of nodes 504 in the compliance graph, with edges (e.g., arrows with “OK” text) connecting adjacent nodes (e.g., rectangular boxes) included within the plurality of nodes 504.

In some embodiments, the condition may be related to an input a user provides for another field (e.g., Foreign Country) included in the second section 408 of the form 402. For example, if the user inputs a value indicating the entity (e.g., business) is in the United States, then user may skip (e.g., leave blank) the plurality of nodes 504 in the logical flow of the compliance graph 500. This is depicted in the compliance graph 500 by edge 506 connecting node 502 to node 508 of the compliance graph 500, which may correspond to the next condition in the workflow that may affect whether the user can skip (e.g., leave blank) one or more other fields included in the form 402 or another from included in a set of forms related to the workflow.

In contrast, if the user inputs a value indicating the entity is not located in the United States, then the user cannot skip (e.g., leave blank) the plurality of nodes 504 in the logical flow of the compliance graph 500. This is depicted in the compliance graph 500 by edge 510 connecting node 502 to a first node 512 included in the plurality of nodes 504.

### Example Operations for Automatically Generating a Compliance Graph for a Workflow

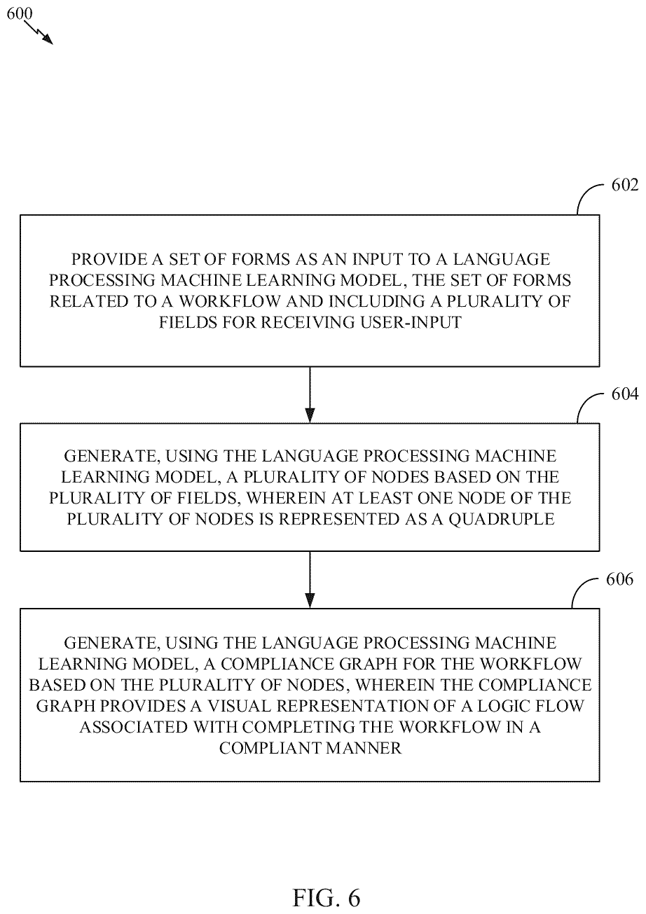

FIG. 6 is a flow diagram of example operations 600 for automatically generating a compliance graph for a workflow according to some embodiments of the present disclosure. The operations 600 may be performed by instructions executing in a computing environment, such as the computing environment 200 discussed above with reference to FIG. 2.

Operation 602 includes providing a set of forms as an input to a language processing machine learning model. For instance, the set of forms (e.g., the set forms 232 discussed above with reference to FIG. 2) may be related to the workflow and each form included in the set of forms may include a plurality of fields for receiving user-input Operation 604 may include generating, using the language processing machine learning model, a plurality of nodes based on the plurality of fields. Furthermore, at least one node of the plurality of nodes may be represented as a quadruple (e.g., type, condition(s), rationale, associated field(s)).

In some embodiments, generating the plurality of nodes may include classifying, using the language processing machine learning model, at least a first field of the plurality of fields as corresponding to a type included in a plurality of different configured types; determining, using the language processing machine learning model, a condition for at least the first field of the plurality of fields, wherein the condition affects whether the first field is skipped in the workflow; determining, using the language processing machine learning model, a rationale for at least the first field of the plurality of fields, the rationale including an explanation for the type or the condition; determining, using the language processing model, at least a second field of the plurality of fields is related to the first field based on the condition; and generating, using the language processing model, the plurality of nodes, wherein at least the node based on the first field is represented as the quadruple.

Operation 606 may include generating, using the language processing machine learning model, the compliance graph for the workflow based on the plurality of nodes, wherein the compliance graph provides a visual representation of a logic flow associated with completing the workflow in a compliant manner (e.g., in compliance with one or more regulatory requirements associated with completing the workflow).

In some embodiments, the operations may further include displaying the compliance graph for viewing by a user. For example, the operations may include displaying the compliance graph on a display screen (e.g, display screen 222 in FIG. 2) of a user device. In this manner, a user may manually verify the accuracy of the compliance graph and, if needed, may provide user feedback associated with correcting one or more errors identified in the compliance graph. Furthermore, as previously mentioned, the user feedback may, in some embodiments, be used to train a machine learning model to automatically validate (e.g., for consistency and accuracy) compliance graphs generated by the language processing machine learning model. Also, in some embodiments, the user feedback on a compliance graph generated by the language processing machine learning model may be used to adjust prompts or examples that are provided as inputs to the machine learning model to perform the different functions (e.g., node classifier 214, node associator 216, and graph builder 217) discussed above with reference to FIGS. 2 and 3.

### Example Operations for Performing a Workflow

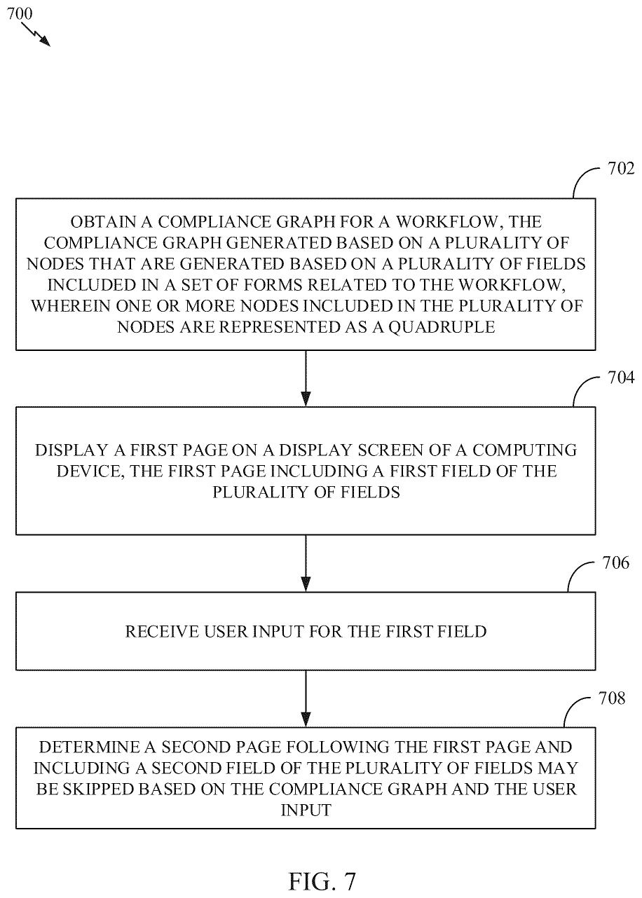

FIG. 7 is a flow diagram of example operations 700 for performing a workflow according to some embodiments of the present disclosure. The operations 700 may be performed by instructions executing in a computing environment, such as the computing environment 200 discussed above with reference to FIG. 2.

Operation 702 may include obtaining a compliance graph for the workflow, the compliance graph generated based on a plurality of nodes that are generated based on a plurality of fields included in a set of forms related to the workflow. Furthermore, one or more nodes included in the plurality of nodes are represented as a quadruple.

Operation 704 may include displaying a first page on a display screen of a computing device. The first page may include a first field of the plurality of fields.

Operation 706 may include receiving user input for the first field. For example, in some embodiments, the computing device may include a user interface that the user may interact with (e.g., by touching the display screen) to provide the user input.

Operation 708 may include determining a second page following the first page and including a second field of the plurality of fields may be skipped based on the compliance graph and the user input for the first field. For example, the second field included on the second page may be skipped (e.g., left blank) depending on user-input provided for the first field included on the first page. Thus, a determination may be made on skipping the second field based on the logical flow depicted by the compliance graph and the user input provided at operation 706.

### Example Computing System

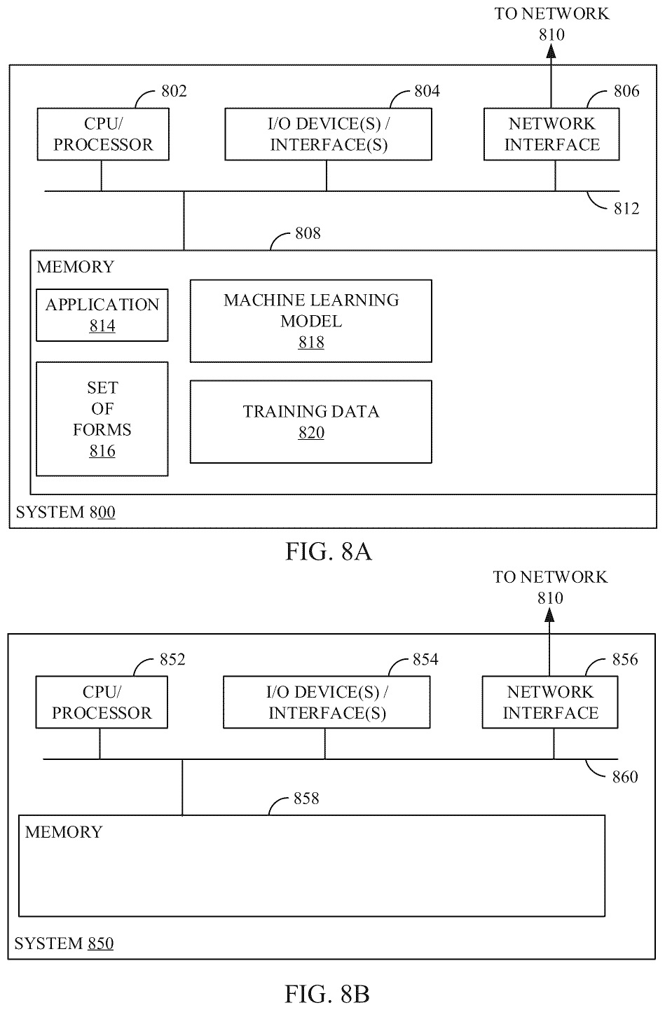

FIG. 8A illustrates an example computing system 800 with which embodiments of the disclosure related to automatically generating a compliance graph for a workflow may be implemented. For example, the computing system 800 may be representative of the server 210 of FIG. 2.

The computing system 800 includes a central processing unit (CPU) 802, one or more I/O device interfaces 804 that may allow for the connection of various I/O devices 804 (e.g., keyboards, displays, mouse devices, pen input, etc.) to the computing system 800, a network interface 806, a memory 808, and an interconnect 812. It is contemplated that one or more components of the computing system 800 may be located remotely and accessed via a network 810. It is further contemplated that one or more components of the computing system 800 may include physical components or virtualized components.

The CPU 802 may retrieve and execute programming instructions stored in the memory 808. Similarly, the CPU 802 may retrieve and store application data residing in the memory 808. The interconnect 812 transmits programming instructions and application data, among the CPU 802, the I/O device interface 804, the network interface 806, the memory 808. The CPU 802 is included to be representative of a single CPU, multiple CPUs, a single CPU having multiple processing cores, and other arrangements.

Additionally, the memory 808 is included to be representative of a random access memory or the like. In some embodiments, the memory 808 may include a disk drive, solid state drive, or a collection of storage devices distributed across multiple storage systems. Although shown as a single unit, the memory 808 may be a combination of fixed and/or removable storage devices, such as fixed disc drives, removable memory cards or optical storage, network attached storage (NAS), or a storage area-network (SAN).

As shown, the memory 808 includes application 814, set of forms 816, machine learning model 818 and training data 820, which may be representative of software application 212, set of forms 232, training data 234 and 236 of FIG. 2.

FIG. 8B illustrates an example computing system 850 with which embodiments of the disclosure related to automatically generating a compliance graph for a workflow may be implemented. For example, the computing system 850 may be representative of the user device 220 of FIG. 2.

The computing system 850 includes a central processing unit (CPU) 852, one or more I/O device interfaces 854 that may allow for the connection of various I/O devices 854 (e.g., keyboards, displays, mouse devices, pen input, etc.) to the computing system 850, a network interface 856, a memory 858, and an interconnect 860. It is contemplated that one or more components of the computing system 850 may be located remotely and accessed via a network 852 (e.g., which may be the network(s) 250 of FIG. 2). It is further contemplated that one or more components of the computing system 850 may include physical components or virtualized components.

The CPU 852 may retrieve and execute programming instructions stored in the memory 858. Similarly, the CPU 862 may retrieve and store application data residing in the memory 858. The interconnect 862 transmits programming instructions and application data, among the CPU 852, the I/O device interface 854, the network interface 856, the memory 858. The CPU 852 is included to be representative of a single CPU, multiple CPUs, a single CPU having multiple processing cores, and other arrangements.

Additionally, the memory 858 is included to be representative of a random access memory or the like. In some embodiments, the memory 858 may include a disk drive, solid state drive, or a collection of storage devices distributed across multiple storage systems. Although shown as a single unit, the memory 858 may be a combination of fixed and/or removable storage devices, such as fixed disc drives, removable memory cards or optical storage, network attached storage (NAS), or a storage area-network (SAN).

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a data store or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more. ” Unless specifically stated otherwise, the term “some” refers to one or more. No claim element is to be construed under the provisions of 35 U.S. C. § 112(f) unless the element is expressly recited using the phrase “means for” or, in the case of a method claim, the element is recited using the phrase “step for. ” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for automatically generating a compliance graph for a workflow, the method comprising:
providing a set of forms as an input to a language processing machine learning model, the set of forms related to the workflow and including a plurality of fields for receiving user-input;
generating, using the language processing machine learning model, a plurality of nodes based on the plurality of fields, wherein at least one node of the plurality of nodes is represented as a quadruple; and
generating, using the language processing machine learning model, the compliance graph for the workflow based on the plurality of nodes, wherein the compliance graph provides a visual representation of a logic flow associated with completing the workflow in a compliant manner.

2. The method of claim 1, wherein generating the plurality of nodes comprises:
classifying, using the language processing machine learning model, at least a first field of the plurality of fields as corresponding to a type included in a plurality of different configured types;
determining, using the language processing machine learning model, a condition for at least the first field of the plurality of fields, wherein the condition affects whether the first field is skipped in the workflow;
determining, using the language processing machine learning model, a rationale for at least the first field of the plurality of fields, the rationale including an explanation for the type or the condition;
determining, using the language processing machine learning model, at least a second field of the plurality of fields is related to the first field based on the condition determined for the first field; and
generating, using the language processing machine learning model, the plurality of nodes, wherein at least a first node of the plurality of nodes and based on the first field is represented as the quadruple.

3. The method of claim 2, wherein determining the type for the first field of the plurality of fields comprises:
providing training data as an input to the language processing machine learning model, the training data associated with training the language processing machine learning model to classify each of the plurality of fields as one of the plurality of different configured types.

4. The method of claim 3, wherein the training data comprises one or more few-shot training examples related to classifying each of the plurality of fields as one of the plurality of different configured types.

5. The method of claim 1, further comprising:
validating an accuracy of the compliance graph for the workflow, wherein validating comprises providing the compliance graph to a machine learning model trained to determine an accuracy of the compliance graph.

6. The method of claim 5, wherein the machine learning model is trained based on training data comprising user feedback related to compliance graphs generated for other workflows.

7. The method of claim 1, wherein generating the compliance graph comprises:
providing a prompt as an input to the language processing machine learning model, the prompt including instructions related to a structure of the compliance graph; and
providing training data as an input to the language processing machine learning model, the training data for training the language processing machine learning model to construct the compliance graph.

8. The method of claim 7, wherein the training data comprises one or more few-shot training examples related to constructing compliance graphs having the structure.

9. The method of claim 1, further comprising:
providing the compliance graph for display on a display screen of a computing device.

10. The method of claim 1, wherein the workflow is related to completing an electronic document.

11. A method for performing a workflow, comprising:
obtaining a compliance graph for the workflow, the compliance graph generated based on a plurality of nodes, wherein the plurality of nodes are generated based on a plurality of fields included in a set of forms related to the workflow, and wherein one or more nodes included in the plurality of nodes are represented as a quadruple;
displaying a first page on a display screen of a computing device, the first page including a first field of the plurality of fields;
receiving user input for the first field; and
determining a second page following the first page and including a second field of the plurality of fields may be skipped based on the compliance graph and the user input for the first field.

12. The method of claim 11, further comprising:
responsive to determining the second page may be skipped, displaying a third page following the second page and including a third field of the plurality of fields.

13. The method of claim 11, wherein the workflow is related to completing an electronic document.

14. A system for automatically generating a compliance graph for a workflow, comprising:
one or more processors; and
a memory comprising instructions that, when executed by the one or more processors, cause the system to perform a method comprising:
providing a set of forms as an input to a language processing machine learning model, the set of forms related to the workflow and including a plurality of fields for receiving user-input;
generating, using the language processing machine learning model, a plurality of nodes based on the plurality of fields, wherein at least one node of the plurality of nodes is represented as a quadruple; and
generating, using the language processing machine learning model, the compliance graph for the workflow based on the plurality of nodes, wherein the compliance graph provides a visual representation of a logic flow associated with completing the workflow in a compliant manner.

15. The system of claim 14, wherein generating the plurality of nodes comprises:
classifying, using the language processing machine learning model, at least a first field of the plurality of fields as corresponding to a type included in a plurality of different configured types;
determining, using the language processing machine learning model, a condition for at least the first field of the plurality of fields, wherein the condition affects whether the first field is skipped in the workflow;
determining, using the language processing machine learning model, a rationale for at least the first field of the plurality of fields, the rationale including an explanation for the type or the condition;
determining, using the language processing machine learning model, at least a second field of the plurality of fields is related to the first field based on the condition determined for the first field; and
generating, using the language processing machine learning model, the plurality of nodes, wherein at least a node of the plurality of nodes and based on the first field is represented as the quadruple.

16. The system of claim 15, wherein determining the type for the first field of the plurality of fields comprises:
providing training data as an input to the language processing machine learning model, the training data associated with training the language processing machine learning model to classify each of the plurality of fields as one of the plurality of different configured types.

17. The system of claim 16, wherein the training data comprises one or more few-shot training examples related to classifying fields as one of the plurality of different configured types.

18. The system of claim 14, wherein the method further comprises:
validating an accuracy of the compliance graph for the workflow, wherein validating comprises providing the compliance graph to a machine learning model trained to determine an accuracy of the compliance graph.

19. The system of claim 18, wherein the machine learning model is trained based on training data comprising user feedback related to compliance graphs generated for other workflows.

20. The system of claim 14, wherein generating the compliance graph comprises:
providing a prompt as an input to the language processing machine learning model, the prompt including instructions related to a structure of the compliance graph; and
providing training data as an input to the language processing machine learning model, the training data for training the language processing machine learning model to construct the compliance graph.
